(19) United States
(12) Patent Application Publication
(10) Pub. No.: US 2007/0176381 A1
(43) Pub. Date: Aug. 2, 2007

(54) Wheeled device for bag-like container and method with regard to the device

(75) Inventor: Remco Van Rheenen, Amersfoort (NL)

Correspondence Address: BROOKS KUSHMAN P.C., 1000 TOWN CENTER, TWENTY-SECOND FLOOR, SOUTHFIELD, MI, 48075, US

(73) Assignee: 2BMOVED HOLDING B.V., Utrecht (NL)

(21) Appl. No.: 10/599,164

(22) PCT Filed: Mar. 23, 2005
(86) PCT No.: PCT/NL05/00219

§ 371 Date: Sep. 21, 2006

(30) Foreign Application Priority Data
Mar. 23, 2004 (NL) 1025794
Jun. 11, 2004 (NL) 1026400

(51) Int. Cl. B62B 3/00

(52) U.S. Cl. 280/47.34

(57) ABSTRACT

The present invention relates to a mobile device for a deformable container, comprising: a frame, wheels arranged on the frame for moving the device, fastening means arranged on the frame for fastening the top part of the container, at least one support member for supporting the container, wherein the device comprises tilting means for tilting the support member relative to the frame. The frame preferably comprises engaging means for releasably engaging the support member.

The present invention relates to a mobile device for a deformable container, in particular so-called big-bags. The invention further relates to a method for off-loading a deformable container from such a device.

Deformable containers (big-bags) have been in use for some time for temporary storage and transport in practical manner of quantities of material between the quantity of a few refuse bags of for instance 60 litres and relatively large containers of several thousand litres. A common size of big-bag is about a thousand litres, such as for instance 90×90×110 cm or 100×100×100 cm. The filled weight of a big-bag generally lies between several tens of kilos to several thousand kilos. Applications for big-bags are for instance the disposal of demolition material or the delivery of construction materials.

The displacing of a full big-bag is problematic. A full big-bag cannot generally be lifted by one, two, three or four persons.

An object of the present invention is to provide a device wherein the big-bag can be handled in simple manner. In order to achieve this objective, the present invention provides a mobile device for a deformable container, comprising:
a frame,
wheels arranged on the frame for moving the device,
fastening means arranged on the frame for fastening the top part of the container,
at least one support member for supporting the container, wherein the device comprises tilting means for tilting the support member relative to the frame. Using a device according to the invention a big-bag can be transported in simple manner, even if it is filled with heavy materials. A filled big-bag can for instance be placed on the mobile device according to the present invention with a lifting device, whereafter it can be transported. Alternatively, it is possible to place an empty, almost empty or still relatively light big-bag on the mobile device according to the present invention, whereafter it can be further filled and, when full and heavy, can be transported in simple manner using the mobile device.

For the purpose of placing the big-bag it is recommended that the frame is open on at least one side for passage of the deformable container or big-bag. For operation of the support member the mobile device preferably comprises engaging means for releasably engaging the support member. After the support member has been released, it is tilted in the direction of the open side of the frame, whereafter the big-bag can slide off the support member under the influence of or at least assisted by gravity. Simple offloading of a heavy, filled big-bag hereby becomes possible.

It is recommended for this purpose that the support member comprises a substantially flat upper side or that the flat upper side has, in the sliding direction of the big-bag, a profile suitable for sliding.

In a further preferred embodiment, the support member comprises a plate having thereunder strengthening ribs in at least one direction. A very strong support member hereby becomes possible at low production cost.

In a further preferred embodiment, the support member is tiltable along at least one axis about a rotation axis. Other tilting means, such as bearing-mounted spheres or cones, are also possible here.

The support member is preferably supported substantially in the centre thereof relative to the frame. This has the advantage for instance that if the loading of the big-bag is somewhat asymmetrical, whereby release of the engaging means may proceed with some difficulty, the load on the engaging means can be reduced simply by pulling or pushing on the big-bag, whereby it will be released more readily.

In a further preferred embodiment, the support member is supported slightly eccentrically relative to the frame. Depending on the load, such an embodiment may be practical in releasing of the big-bag.

At least one of the wheels is preferably arranged for swivelling on the frame. A number of swivel wheels increases the manoeuvrability of the mobile device.

For moving the device a pull or push member can be provided on at least one side of the frame. Depending on the situation of use, one or more persons may be occupied in actually moving the mobile device using such a pull or push member. The use of a correct wheel type in respect of the type of ground surface is of particular importance here. The skilled person will enhance the convenience of use of the device by selecting a correct wheel type.

Also possible for the purpose of moving the device is a motor drive for driving one or more of the wheels.

A further aspect of the invention relates to a method for offloading a deformable container such as a big-bag from a device as specified in the foregoing, comprising steps for:
tilting the support member by means of the engaging means,
allowing the container to slide off the support member in the direction of the ground surface so that it makes partial contact with the ground surface,
moving the device away, wherein the container is held in its position by friction between the part making contact with the ground surface. An advantage of this method is that a big-bag which is much too heavy for a person to handle can be offloaded in practical manner from a mobile device according to the present invention.

Further advantages, features and details of the present invention will be elucidated with reference to the accompanying figures, in which:

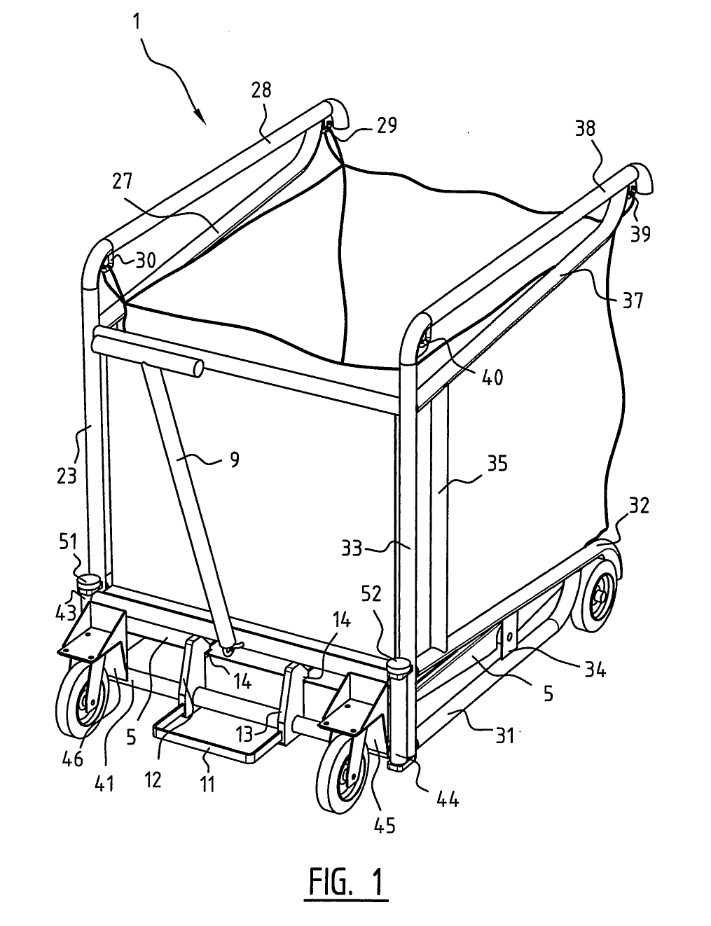

FIG. 1 shows a view in perspective of an embodiment according to the present invention;

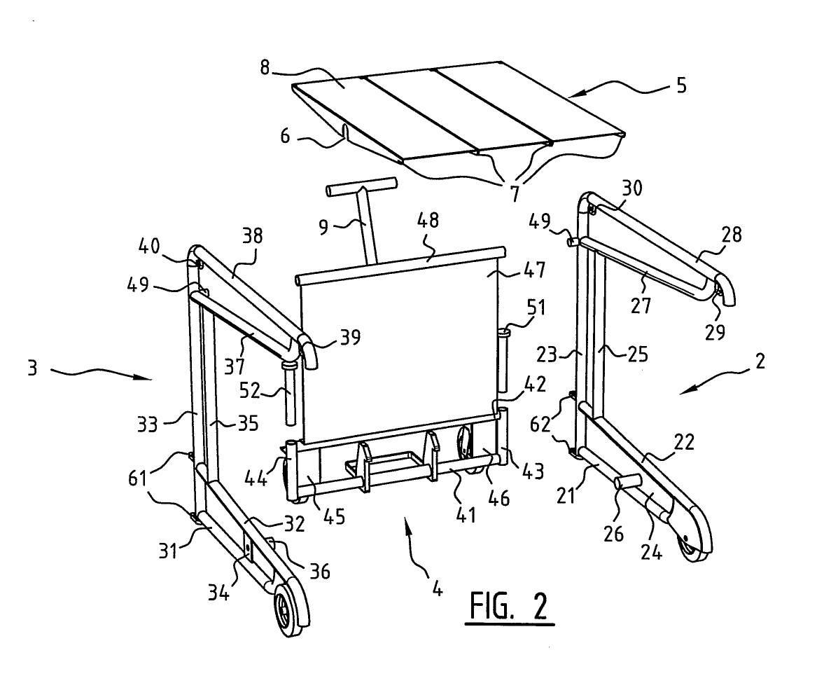

FIG. 2 is an exploded view in perspective of the embodiment of FIG. 1;

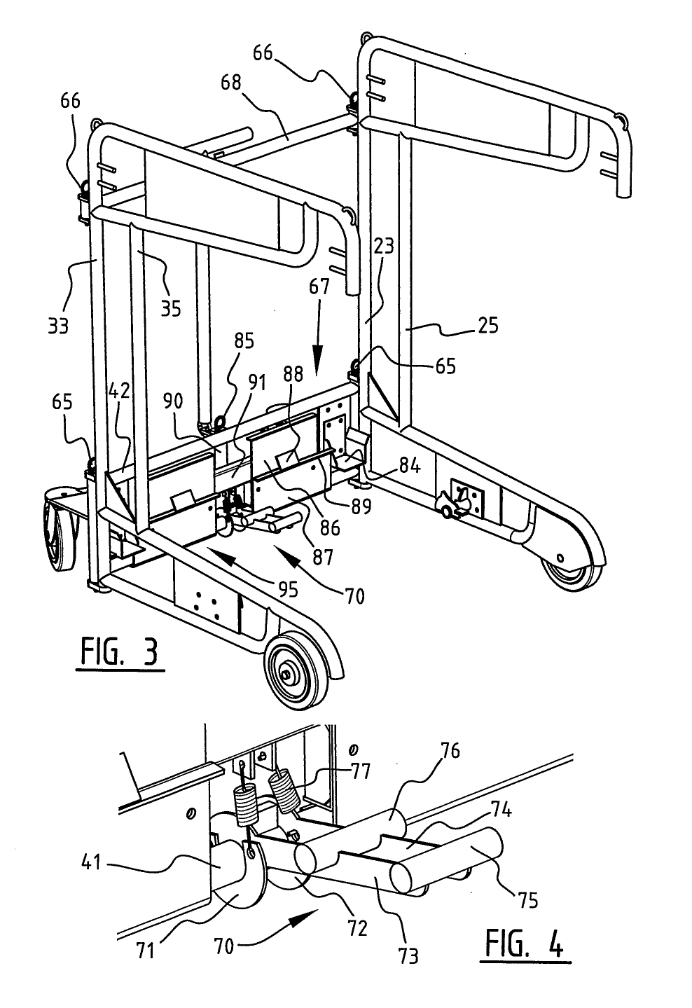

FIG. 3 is a view in perspective of a further embodiment according to the present invention;

FIG. 4 shows a detail of the embodiment of FIG. 3;

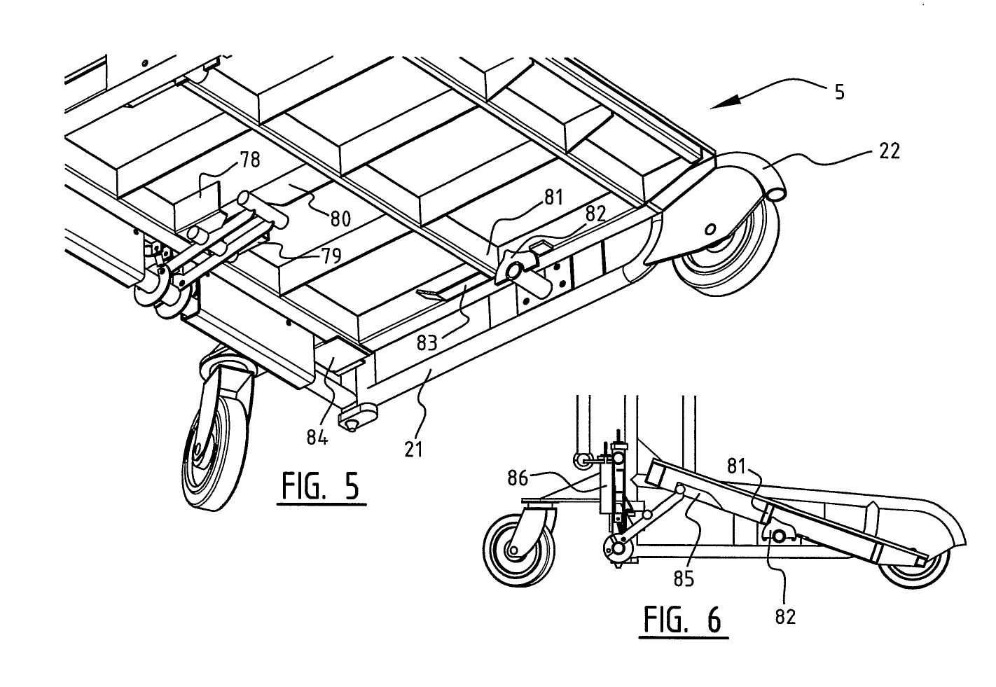

FIG. 5 shows a bottom view of the embodiment of FIG. 3; and

FIG. 6 is a side view of a part of the embodiment of FIG. 3.

An embodiment according to the present invention (FIG. 1) is a supporting vehicle 1 for a big-bag B-B. This device is assembled from a side part 2, a side part 3, a middle part 4 and a base plate 5. Base plate 5 is strengthened by means of ribs 7. The ribs are provided with a recess 6 for receiving therein a rod (not shown) or support protrusions 36, 26 of trolley 1. The left-hand side part 2 comprises a lower, substantially horizontally extending element formed by tubes 21, 22 and strengthening plate 24. A bearing element 26 is fixed in strengthening plate 24 for supporting the base plate. Vertical tubes 23 and 25 extend upward from the lower part formed by tubes 22 and 21. Situated on the top side of the side part are tubes 27, 28 which form a horizontally extending part of the side frame. Arranged hereon are two fastening hooks 29 and 30 which serve to support loops of the big-bag.

A frame side part 3 is likewise situated on the other side of the trolley. This takes the same form as the other side part. Situated at the bottom is a substantially horizontally extending part formed by tubes 31, 32. Extending between these is a strengthening and fixing part 34. A support stub 36 is mounted on this fixing part 34. Tubes 33, 35 extend upward from tubes 31 and 32 in vertical direction. A substantially horizontally extending supporting part formed by tubes 37 and 38 is connected to the top of these tubes 33, 35. Located hereon for fastening of further loops of the big-bag are hooks 39 and 40. An option is to arrange a shaft between element 26 and stub 36.

The middle part of the trolley is formed by horizontal tubes 41 and 42 which are mutually connected by means of of vertical tubes 43 and 44. A plate 47 extends from tube 42 to tube 48 at the top of the middle part. The middle part can be attached to or between the two side parts by means of fastening supports 49 mounted on the inner side of side frames 2 and 3. These slide into the horizontal tube 48 of middle part 4. Tubes 44 and 43 are situated on the underside of the middle part. During assembly of the trolley these fit respectively between eyes 62 and 61. After placing of tubes 43 and 44 between eyes 62 and 61 respectively, fixing rods 51 and 52 are placed therein. The trolley hereby has a sturdy assembly. Described here is an embodiment of the trolley which can be disassembled. The invention can also be realized by means of a trolley wherein all components are permanently fixed to each other by means of for instance welded connections. During use of the trolley the big-bag will be supported by the top side 8 of plate 5. This plate is arranged in the trolley for tilting about the axis of support rods 26, 36. In order to hold plate 5 in the horizontal position it is arrested in vertical direction close to the middle part 4 of the frame by means of hooks 12 and 13 which have engaging surfaces 14. On the underside the plate is arrested in this position for instance by means of stops (not shown) which are for instance fixed to the inner side of tubes 23, 33 of side frames 2, 3. Between the stops and the underside of engaging surfaces 14 there is preferably a distance substantially equal to or a little greater than the thickness of plate 5 at that position.

In the arrangement as specified in the foregoing the support plate 5 is situated substantially in horizontal position when grippers 12, 13 engage thereon. A big-bag is then placed in or on the trolley. If the big-bag is empty when placed, the loops of the big-bag will be fastened to hooks 29, 30, 39, 40. The big-bag will hereby retain its for instance cube-shaped exterior during filling thereof. If after filling the big-bag has acquired a mass such that it can no longer be lifted out of the trolley by manual effort, the trolley is positioned at the location where the big-bag has to be offloaded. By operating the hooks 12, 13 by means of a downward movement of pedal 11 the support plate 5 can then be released. With a suitable weight distribution of the big-bag and the base plate relative to support elements 26, 36 the support plate 5 will hereby tilt, whereby the big-bag will slide off plate 5. The upper surface 8 of the support plate is preferably provided for this purpose with a suitable profile, being for instance either flat or provided with ridges in the sliding direction. The big-bag will hereby slide partly onto the ground surface around the trolley. In order to offload the big-bag the trolley can then be simply pulled away from under the big-bag in the direction of middle frame 4. Using this embodiment according to the present invention it is therefore possible by means of a simple construction to transport a very heavy big-bag with manual effort to a position where it has to be offloaded. The use of heavy transporting means, which because of their size cannot be used everywhere, is unnecessary here. Trolley 1 can optionally be provided with a drive motor with a suitable driving to at least one of the wheels.

Wheels 63 mounted on the outer ends of the lower horizontal frame parts formed by tubes 21, 22 and 31, 32 respectively are mounted fixedly in this embodiment. Wheels 64 on the other side of these frame parts are mounted for swivelling. The trolley can hereby be displaced in simple manner by means of pull rod 9. It is likewise possible to give all wheels a swivelling form. It is also possible to give wheels 63 a swivelling form and wheels 64 a fixed form.

Components of FIGS. 3-6 that are similar to components of FIGS. 1 and 2 are designated with the same reference numerals. The frame part designated 4 in FIG. 2 is embodied in the embodiment of FIG. 3 by means of a two-part frame comprising upper tube 68 and lower frame part 67. The horizontal tubes of lower frame part 67 are once again designated 41 and 42. These are mutually connected by means of vertical tubes 43 and 44 so as to form a frame part 67. Upper tube 68 is fixed to the two side frames 2 and 3 by means of fastening pins 66 provided with an eye. Frame part 67 is fixed to side frames 2 and 3 by means of pins 65 likewise provided with eyes.

Frame part 67 is provided with stops 84 for positioning thereon of support plate 5.

Frame part 67 is further provided with a hook mechanism 95 for fixedly holding support plate 5. In this embodiment this hook mechanism takes a dual form on the left and right-hand side of the holding-down means 70. This hook mechanism comprises a central fixing beam 91 to which the fixing plate 86 is attached by means of for instance welding or other appropriate fixing method. On the underside of central beam 91 this plate 86 is bent in order to serve as fixing of plate 86 from the top on frame tube 41.

In order to engage on support plate 5 the plate 87 is provided with a protruding edge 89 which is strengthened by means of a strengthening plate 88.

In this embodiment the frame part 67 further comprises a holding-down means 70 for holding the support plate fixedly in an inclining position for the purpose of offloading a big-bag from support plate 5. This holding-down means comprises two arms 73 and 74 extending pivotally from frame tube 41. Crossbars 75 and 76 are situated on these arms. For pivoting mounting of arms 73, 74 mounting plates 71 and 72 are fixed thereto which extend round frame tube 41. These are provided with springs 77 for pulling arms 73, 74 upward.

This holding-down means 70 co-acts with the construction of the support plate. The support plate is provided on the underside with engaging plates 78, 79. The crossbar 75 of the holding-down means engages in these engaging plates while the support plate tilts from the position shown in FIG. 5 to the position shown in FIG. 6. A central rib 80 on the underside of the support plate is provided for this purpose with a guide slope 85 (FIG. 5).

Crossbar 76 of the holding-down means 70 assists in raising support plate 5 out of the frame. This arm 76 ensures that arm 75 is prevented from engaging in engaging plates 78 and 79 when the support plate is tilted upward at the front when the support plate is lifted out of the frame. Lifting of the support plate out of the frame is hereby simplified. The action of gripper 89 engaging on support plate 5 is as follows. Using rod 9 the whole unit 95 can be pivoted on tube 41. Using pin 85 (FIG. 3) which is placed through an eye on tube 42 into tube 90 of unit 95, the unit 95 can be fixed to tube 42, and thereby to frame part 67. The rod can hereby be used not only to operate support plate 5 but also to move the trolley and the rod can be secured by means of pin 85 (FIG. 3).

A support 82 is situated on either side of the trolley on side frames 2 and 3. This support is provided with a tooth at the top which serves as stop for a rib or support 81 on the underside of the support plate. This rib or support is strengthened by means of a strengthening plate 83.

A further embodiment of a trolley according to the present invention comprises a spring mechanism or a hydraulic mechanism for braking the support plate during tilting thereof. The tilting can hereby be controlled better, particularly when a heavy filled big-bag is situated thereon.

A further embodiment comprises a guide system, such as a rail system, along which the support plate can first move horizontally prior to tilting, whereafter the support plate arrives at the position of a tilting point and can tilt in front of the wheels of the trolley. An advantage hereof is that if a full big-bag falls into a lopsided position it cannot make contact with the wheels of the trolley.

The embodiment shown in the figures and other described embodiment variants can be freely varied in order to obtain embodiment variants which can be realized by the skilled person on the basis of this description. The rights sought are defined by the appended claims.

1. Mobile device for a deformable container, comprising:
a frame,
wheels arranged on the frame for moving the device,
fastening means arranged on the frame for fastening the top part of the container,
at least one support member for supporting the container, wherein the device comprises tilting means for tilting the support member relative to the frame.

2. Device as claimed in claim 1, wherein the frame is open on at least one side for passage of the container.

3. Device as claimed in claim 1, wherein the frame comprises engaging means for reasonably engaging the support member.

4. Device as claimed in claim 1, wherein the support member comprises a substantially flat upper side.

5. Device as claimed in claim 1, comprising a stop for arresting the support member at a predetermined position.

6. Device as claimed in claim 1, wherein the support member comprises a plate having thereunder strengthening ribs in at least one direction.

7. Device as claimed in claim 1, wherein the support member is tiltable about at least one rotation axis relative to a virtual axis.

8. Device as claimed in claim 1, wherein the support member is supported substantially in the centre thereof relative to the frame.

9. Device as claimed in claim 1, wherein the support member is supported eccentrically relative to the frame.

10. Device as claimed in claim 1, wherein at least one of the wheels is arranged for swivelling on the frame.

11. Device as claimed in claim 1, comprising a pull or push member on at least one side of the frame.

12. Device as claimed in claim 1, comprising a motor drive for moving the device.

13. Device as claimed in claim 1, comprising a resistance member for braking the support member during tilting thereof.

14. Device as claimed in claim 1, comprising a guide member for moving the support member substantially from front to rear as seen in the travel direction of the mobile device.

15. Method for offloading a deformable container such as a big-bag from a device as claimed in claim 1, comprising steps for:
tilting the support member by means of the engaging means,
allowing the container to slide off the support member in the direction of the ground surface so that it makes partial contact with the ground surface,
moving the device away, wherein the container is held in its position by friction between the part making contact with the ground surface.
